(19) United States
(12) Patent Application Publication
(10) Pub. No.: US 2006/0058948 A1
(43) Pub. Date: Mar. 16, 2006

(54) RECORDABLE LOCATION-BASED REMINDER SYSTEM ORGANIZER

(75) Inventors: Melanie Blass, La Salle (CA); Karl Istvan Blass, La Salle (CA)

Correspondence Address: Ms. Melanie Magdolna Blass, 5895 Tenth Street, La Salle, N9H 2L7, CA

(73) Assignees: Ms. Melanie Magdolna Blass, La Salle (CA); Mr. Karl Istvan Blass, La Salle (CA)

(21) Appl. No.: 11/161,122

(22) Filed: Jul. 24, 2005

Related U.S. Application Data
(60) Provisional application No. 60/521,969, filed on Jul. 28, 2004.

(51) Int. Cl. G01C 21/00

(52) U.S. Cl. 701/207; 701/213; 455/456.1

(57) ABSTRACT

An organization system using location information, possibly in conjunction with time based information for tasks, with the purpose of optimizing user travel distance and/or time to complete specified tasks. Task organization may include alternate criteria such as importance, or sharing and assigning of tasks over groups to optimize in terms of the time/location/schedule of other members of the group. The mobile system may alert users of some tasks based on the user proximity to those tasks, alert of other tasks based on both time and location, or others based solely on the current time and the time of the task. The system can provide a dynamic schedule, changing based on time estimates of the user tasks as well as actual time to complete user tasks, estimates of travel time between tasks, as well as other criteria.

### CROSS REFERENCE TO RELATED APPLICATIONS

This application claims the benefit of the filing date of U.S. Patent Application No. 60/521,969 filed 28 Jul. 2004 under title RECORDABLE LOCATION-BASED REMINDER SYSTEM ORGANIZER.

### FIELD OF THE INVENTION

The invention relates to location-based memos, journals, navigation systems, as well as commonly used time-based calendars, electronic or otherwise.

### BACKGROUND OF THE INVENTION

Electronic diaries, such as those of U.S. Pat. No. 5,654,908, use methods whereby a user enters data such as schedules, address books, and telephone numbers and then allows the destination data to be transmitted to navigation systems. This system makes data entry more convenient when using navigation systems. Such devices are often merely improvements on device synchronization and data input methods.

Vehicle trackers, mileage-time monitors and calibrators can act as a monitor for vehicle tracking capabilities and while they store mileage, location, and time information, provides no guidance in terms of schedule management nor route optimization.

Navigational services provided on wireless communication devices are commonly used technologies. Examples allow for transmission of selected classifications of information based on user location, and provide navigational information.

The display of real-time information and directional indicators are well documented areas. Some systems provide a method to better guide an individual in terms of directions by overlaying a directional indicator on an image of the individual's current location. This improves the presentation of navigational information.

Information display systems can allow the storage of future appointments and their corresponding locations in a calendar. Some examples are simply ready to navigate to the next location when the time of that task arrives in the calendar.

Systems which display relative location indicators for items have been described in a specific application targeting the task of finding items in a grocery store. There is the option of having all tasks displayed such that a general approximation is given of where one is relative the to items one needs to collect.

Some systems limit the user to a selection server which only contains a database of information and the list is limited to a plurality of items within a set area contained within a database operative to store availability information and location information. The system is limited to the information on the selection server whereby the user asks the server to locate at least two items located within the set geographic area.

Improvements or alternatives to existing location-based organizers are desirable.

### SUMMARY OF THE INVENTION

In a first aspect the invention provides a location based computing system. The system includes a mobile device aware of its location and one or more tasks that a user of the device wishes to perform, and a locations database for storing a plurality of locations and a plurality of tasks that can be performed at the locations. The tasks are associated with the locations and at least one of the tasks can be performed at multiple locations. The system also includes determination means for communication between the mobile device and the database to determine when the mobile device is within a given proximity of a location in the database at which a task can be performed, and notification means for providing a notification to a user through the mobile device when the mobile device is within the given proximity of a location in the database at which a task can be performed.

The mobile device may include a GPS unit through which the device is made aware of its location. The mobile device may include a database for storing tasks that the user wishes to perform.

The location database may be remote from the mobile device, and the mobile device may include a wireless transmitter and receiver through which the mobile device obtains information from the database.

In another aspect the invention provides a location based computing system, partially or entirely portable, comprising a device to receive location information, a memory unit to store information, whereby the memory unit is located either on the mobile device or at a remote accessible location, a software component allowing users to store and/or modify location based information, whereby modifications can occur regardless of device location, capability of outputting information relating to the designated region for the mobile unit upon determining that it is in a set vicinity of the designated region for the information, including a processing unit either on the device or on a companion device, where the companion device could possibly be a component of a networked system, a software component acting as an organizer for location based information. Such organization could be based on, but not limited to: current distance from listed items; importance rankings of listed items; time restraints of items; route planning based on multiple locations and/or time constraints and/or item priority, etc; specific location based information of stored items such as GPS coordinates or alternative equivalent systems.

The output information may further include: location-based information pre-programmed for the user. Such methods may comprise, but are not limited to, information stored in neighboring devices or information pre-programmed by alternate means.

The programs and/or their parameters may be adjustable on the device or, via adaptable means, re-calculated on the device. Such alterations could be, but are not limited to: user specified location deletions or additions to pre-set destination sequences; user additions, deletions or modifications of any information on the device.

The portable device may be a wireless phone, PDA, laptop, or any other mobile unit acting as a medium or entire platform for the system.

The device may calculate distances, directions, and other informative information via information received through, but not limited to: user inputs, communications with other devices, communications internally with pre-programmed information

The location based information may pertain to any information programmable in a device via the device or alternate devices, to inform when the device is in a designated region, or to inform of any preset linked information to the designated region.

The modes can be set by users allowing, but not limited to: status modes such as approachability; device user's route plans possibly for potential pairing or clustering of device users; sharing of location-based lists possibly determined by selecting users to share with; subscribing to user groups, databases, or specific classifications of data within such databases; advertising or posting to create groups;

The location based system may include software rendering the device the capability to record present device locations at regular intervals and store such sequences of locations complete with a label or tag of some description, as well as recording prime points of importance in the sequence, and additive information for those points either while at the point or at any time after the points (and the sequence of locations) have been stored. Sequences programmed in a device are accessible via the label or tag associate with the grouping, but such sequence points can be individually accessed.

The location based system may include a method for determining user orientation and/or direction of travel. Such methods may incorporate but are not limited to methods requiring a compass (electronic or otherwise), or transmitter/receiver distance/time calculation methods.

The location based database information can be grouped in terms of categories, wherein the distinguishing factor amongst a group of information is the location itself. Such results can be, but is not limited to, dynamic usage by the organizer of claim 5.

The location based system may include a fixed record to describe the temporary location of mobile objects, such as but not limited to: vehicles. The location information may be updated or nullified by the user.

The location based information and other relevant related information may be stored in a database that can be accessed (for both uploading and downloading) by a group of persons using the location based system.

In another aspect the invention provides a recordable location-based reminder system to act as an organizer for location-based information alone or in conjunction with other task organization systems. The system has a mobile electronic device with access to location-based information for the device's current location and the location of other task locations. The system employs a method of placing information on the device either through user input methods directly to the device or by downloading the information from a neighboring device such a server of personal computer.

Such a device may be a Personal Computing Device (PCD), a cell phone, or any mobile device with access to location information. Such location information may be obtained using the Global Positioning System (GPS), cell phone triangulation, or alternative means.

The system may include a database of information either stored on the mobile device or on a remote device, such as a server, a web page, or personal computer whereby the remote device can transfer information to the mobile device. The database of information may include a list of tasks the user intends to complete. Additional information can also be stored in the database, such information includes but is not limited to: location of tasks, time of tasks, time-ranges for tasks, priority rankings of tasks, importance of tasks, task duration, and reminder distances for tasks.

These and other aspects of the invention, including for example systems, methods, computer programs, devices, and databases for carrying out a recordable location-based reminder system, will be evident from the detailed description and the drawings herein.

### BRIEF DESCRIPTION OF THE DRAWINGS

For a better understanding of the present invention and to show more clearly how it may be carried into effect, reference will now be made, by way of example, to the accompanying drawings which show the preferred embodiment of the present invention and in which:

FIG. 1 is a diagrammatic illustration of an association of one task with one location as may be used in a preferred embodiment of a location-based reminder system organizer.

FIG. 2 is a diagrammatic illustration of an association of one location with one task as may be used in the embodiment of FIG. 1.

FIG. 3 Is a diagrammatic illustration of an association of one location with multiple tasks as may be used in a preferred embodiment of a location-based reminder system organizer.

FIG. 4 is a diagrammatic illustration of an association of one task with multiple locations as may be used in a preferred embodiment of a location-based reminder system organizer.

FIG. 5 is a diagrammatic illustration of an association of one task associated with many locations, one location associated with many tasks as may be used in the embodiment of FIG. 1.

FIG. 6.1 is a diagrammatic illustration of example information organization tables as may be used in the embodiment of FIG. 1.

FIG. 6.2 is a diagrammatic illustration of further example information organization tables as may be used in the embodiment of FIG. 1.

FIG. 7 is a diagrammatic illustration of sharing tasks to be completed based on location and time as may be used in the embodiment of FIG. 1.

FIG. 8 is a series of task pad menu flow charts as may be used in the embodiment of FIG. 1.

FIG. 9 is a diagrammatic illustration of support for mobile objects on task lists as may be used in the embodiment of FIG. 1.

FIG. 10 is a diagrammatic illustration of support for moving targets as may be used in the embodiment of FIG. 1.

FIG. 11(a) is an illustration of unorganized routes created without a device according to the embodiment of FIG. 1 versus

FIG. 11(b) organized routes as can be supported by the embodiment of FIG. 1.

FIG. 12 is a block diagram of a user and physical elements of a recordable location-based reminder system organizer (RLRSO) according to the preferred embodiment of the present invention referred to in FIG. 1.

FIG. 13(a) is a chart-based illustration of the database of FIG. 12 from a task perspective(column representation).

FIG. 13(b) is a chart-based illustration of the database of FIG. 12 from a task perspective(row representation).

FIG. 14(a) is a chart-based illustration of the database of FIG. 12 from a location perspective (column representation).

FIG. 14(b) is a chart-based illustration of the database of FIG. 12 from a location perspective (row representation).

FIG. 15 is a chart-based illustration of the database of FIG. 12 populated with an example from a task perspective

FIG. 16(a), (b) database of FIG. 12 populated with an example from location perspective

FIG. 17(a) is an example flow diagram of the embodiment of FIG. 12.

FIG. 17(b) is an example of predefined processes in the flow diagram of FIG. 17(a).

FIG. 18 is a block diagram of example hardware, software, and database interactions in the embodiment of FIG. 12 when using an externally accessible database.

FIG. 19 is a block diagram of example hardware, software, and database interactions in the embodiment of FIG. 12 when using an internally accessible database.

### DETAILED DESCRIPTION OF THE PREFERRED EMBODIMENTS

Referring to FIG. 6.1, a sample of possible lists of criteria for organization are shown. Each list contains items or criteria that are associated with items on other lists.

Referring to FIG. 6.2 association for a given task are demonstrated. In this example the task is going to a library, we note that the task is associated with a time of 10 minutes, thus the duration of time the user is to be in the library is expected to be approximately 10 minutes. Notice that there are some associations with more than one criterion in a category; this is an example of one task with multiple locations. The task “library” is associated with multiple library locations. The user can find their books at any of these locations. Also demonstrated is the use of priority. The task does not have to be done immediately, and using the distance metric (100 meters for this example), when the user is within this distance of one of their library locations, the user will be alerted. As illustrated in FIG. 6.1, there may be many other criteria including the usage of time availability of tasks.

Using location based information for the current location of the mobile device, and various computational algorithms to co-ordinate the information in the database with the user's location, a processor located either on the device or on a remote device, such as a server, can process computational methods, typically under software control, to determine alerts or optimal routes for a user based on their selection criteria. Such algorithms may include, but not be limited to methods commonly used in the traveling salesman problem, kruskal's algorithm, prim's algorithm, and various other formulated optimization algorithms or graph theory methodologies.

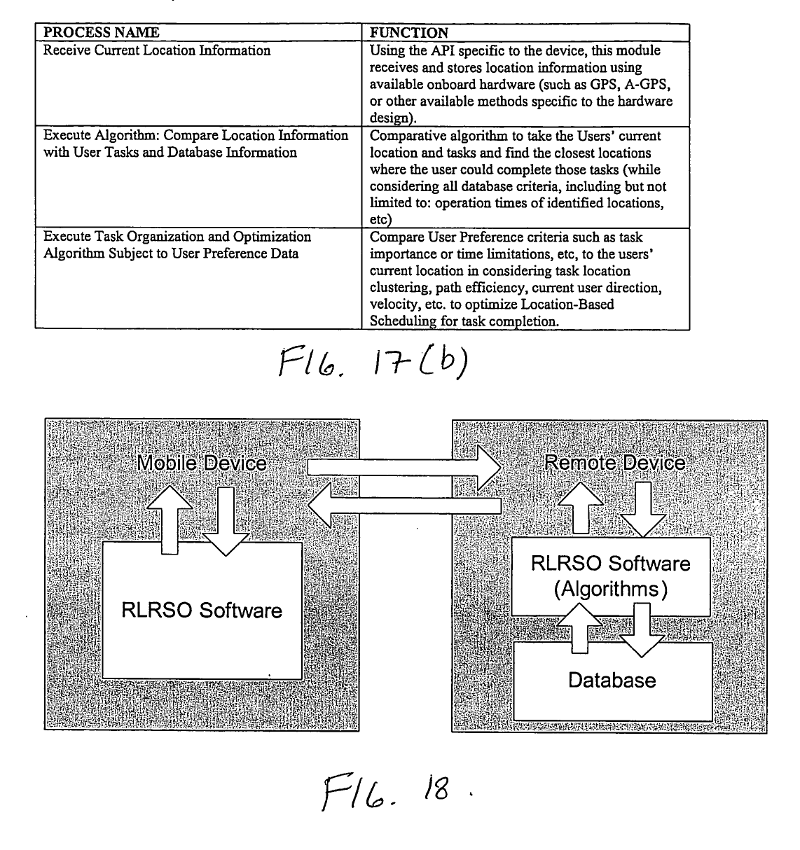

Referring to FIG. 17(a), an example software flow diagram depicting the general flow of processes for RLRSO software is shown.

Referring to FIG. 17(b), predefined processes for the software flow of FIG. 17(a) are defined.

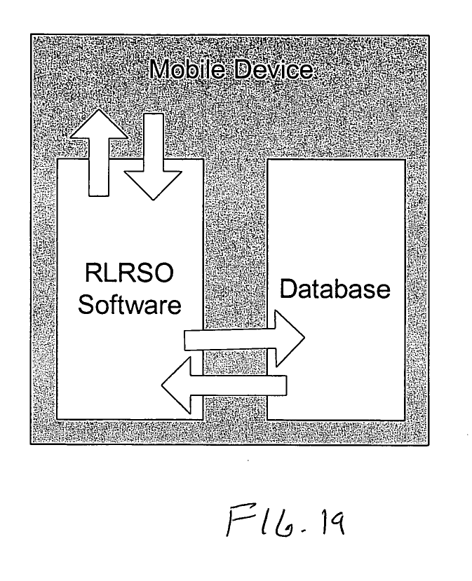

Referring to FIGS. 18 and 19, interactions between the hardware, software, and the database are shown in the following example sets of possible configurations.

The first configuration is depicted in the block diagram of FIG. 18, where the database is on an external remote device (such as a database on another PC which has networking capabilities), the second configuration is shown in FIG. 19, where the mobile device maintains database information on the unit itself, and the third is a combination of the first and second configurations.

In FIG. 18, the RLRSO software is loaded onto the mobile device. The software interacts with the device by using its hardware to contact a remote device in order to interact with the database on that remote device. The mobile device uses wireless technology (transmitters and receivers, possibly communicating through cell phone towers) to communicate with the remote device.

The remote device is generally another computer containing memory, a processor, an internet connection (or method of sending e-mails, SMS, or other data transmissions), and it may also contain RLRSO software to interact with the databases on the remote devices and/or the user's mobile device. RLRSO software-based algorithms can be run on the remote device in order to deduce what information (if any) to send to the mobile device. If information is to be sent to the mobile device user, then the RLRSO software on the remote device uses the remote devices hardware to send notification (via e-mail, SMS, or other data transmission) to the mobile device, and specifically to the RLRSO software on the mobile device.

The second example configuration is that of FIG. 19 which illustrates database information stored on the mobile device. In this embodiment the RLRSO software and database are stored on the hardware configuration of the mobile device. The RLRSO obtains location information from the hardware of the mobile device as well as interacting with the database to access required information. The software also runs the appropriate algorithms on the database information and combined they determine how and when to notify the user. The RLRSO software communicates with the mobile device user through the mobile device's hardware configuration and usage of the API's appropriate for that mobile device.

Alternatively a combination of FIG. 18 and FIG. 19 allowing for a device to have an onboard database in conjunction with a remote storage facility, would allow for immediate access to the onboard database, and the option of connecting to the remote database for information that is not currently available in the onboard database.

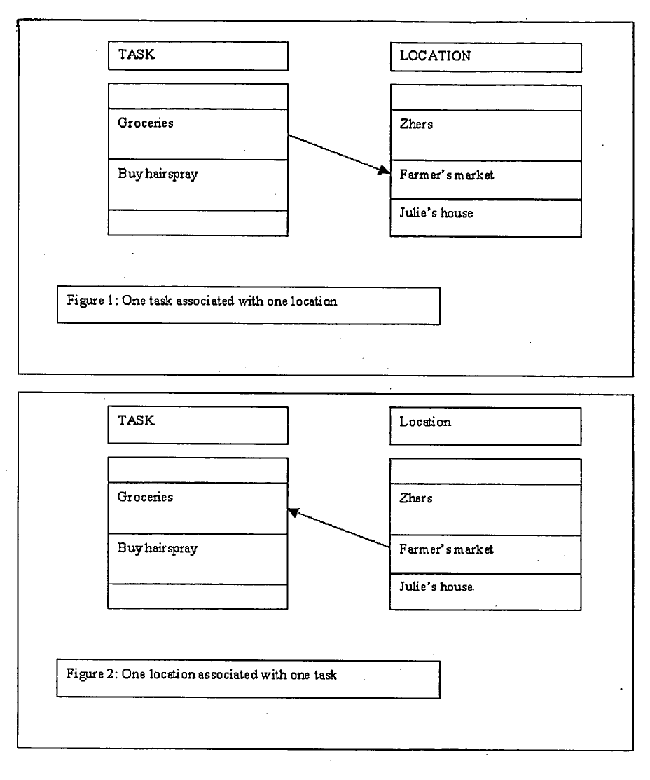

As depicted in FIG. 1, each task can be associated with a given location such that when the task is to be completed, the current location of the user and the location of the task can be used to direct the user towards the location of the task.

Similarly as shown in FIG. 2, a location can be associated with a task such that when the device is in the vicinity of the task it can alert the user that the task is nearby. Such alert methods are optimal for tasks of lower priority, which can be completed with some flexibility or even independence of time constraints.

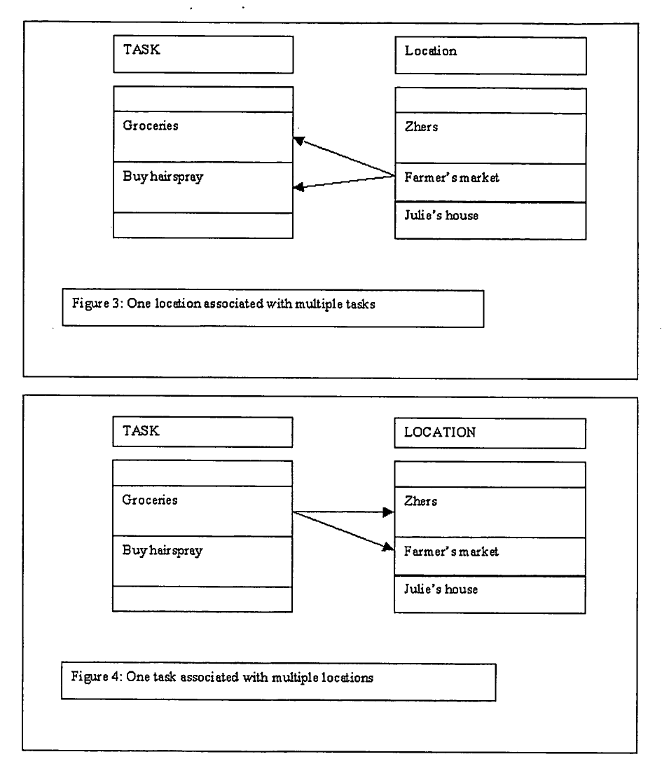

As shown in FIG. 3, we see that one task, such as picking up library books, can occur in multiple locations since there are multiple book stores. Similarly picking up groceries since there are various grocery stores, these are examples of one task having multiple associated links to location information, however this scenario of one-to-many can happen between various criteria lists and is not limited to the task-location example provided.

Tasks, locations, and other criteria need not be entirely deleted from the system once they are completed, but merely disassociated with their related criteria. For example, if a task is complete, the task name can be disassociated with the list of tasks that must still be completed, and the item will not appear in the task list. Some tasks are relatively repetitive, (such as groceries) and so the word groceries is preferably not deleted, but rather dissociated from the task list. Later, when selecting what tasks to do, a user can scroll through a list of common tasks and simply select groceries when it is to be placed back on the task list. Similarly, locations can be stored if a user may want to visit again in the future, but may not be associated with a task until a later time. Alternatively, a task can be entered to complete but a location may not be immediately specified for the task. Such association and dissociation techniques are intended to minimize the constant need for re-entering data in the device, thus minimizing more lengthy repetitive behaviors. A full list of locations can be stored on remote devices (such as servers, websites, etc) allowing easy access to selecting list items; tasks, locations, and all associated information can be shared amongst groups of individuals (possibly through a server or other means), thus not requiring a user to ever have been to that location before.

FIG. 4 demonstrates an inverse to FIG. 3, while illustrating how one location can be associated with multiple tasks. Thus when the device is within the set alert distance for a task in that region, the device will be alerted of the task. Since multiple tasks may need to be done in that location, the device may be alerted of multiple tasks.

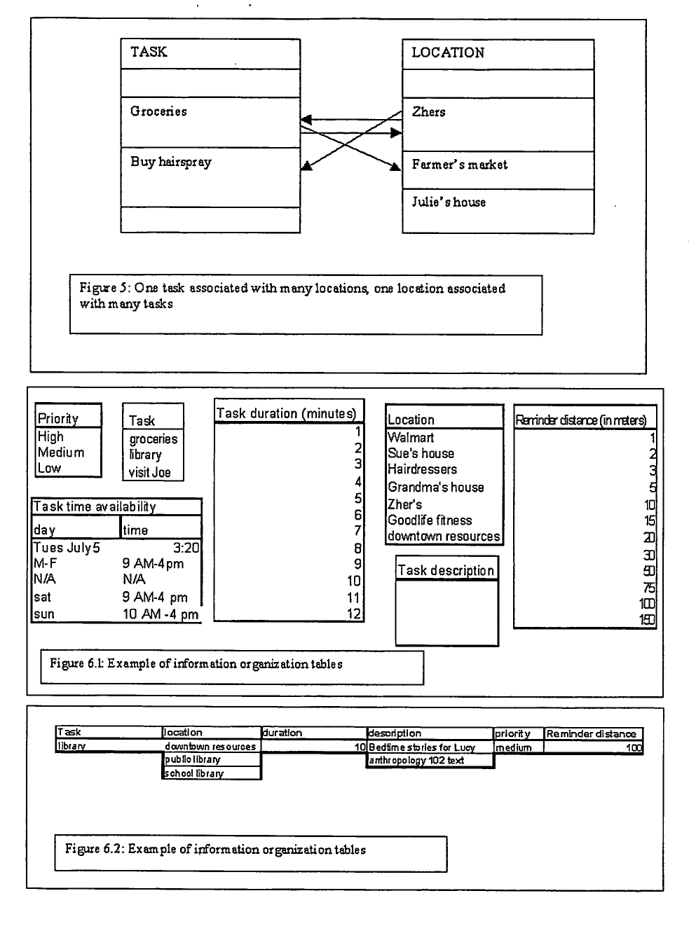

FIG. 5 demonstrates how FIGS. 3 and 4 can occur simultaneously and thus reveal the overlap of criteria within the system. Such criteria overlap is depicted here using tasks with many locations and locations with many tasks, but this scenario is not limited to the task and location criteria; overlap may happen between any and even many of the criteria.

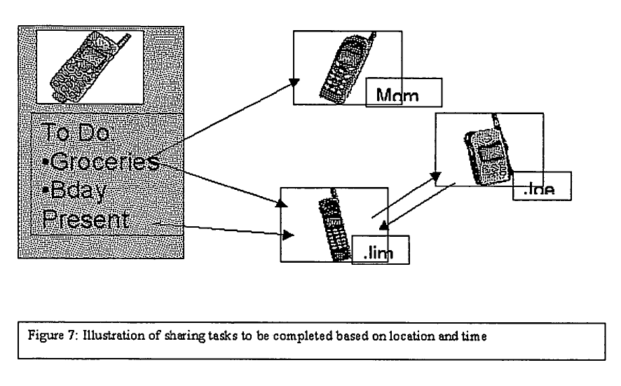

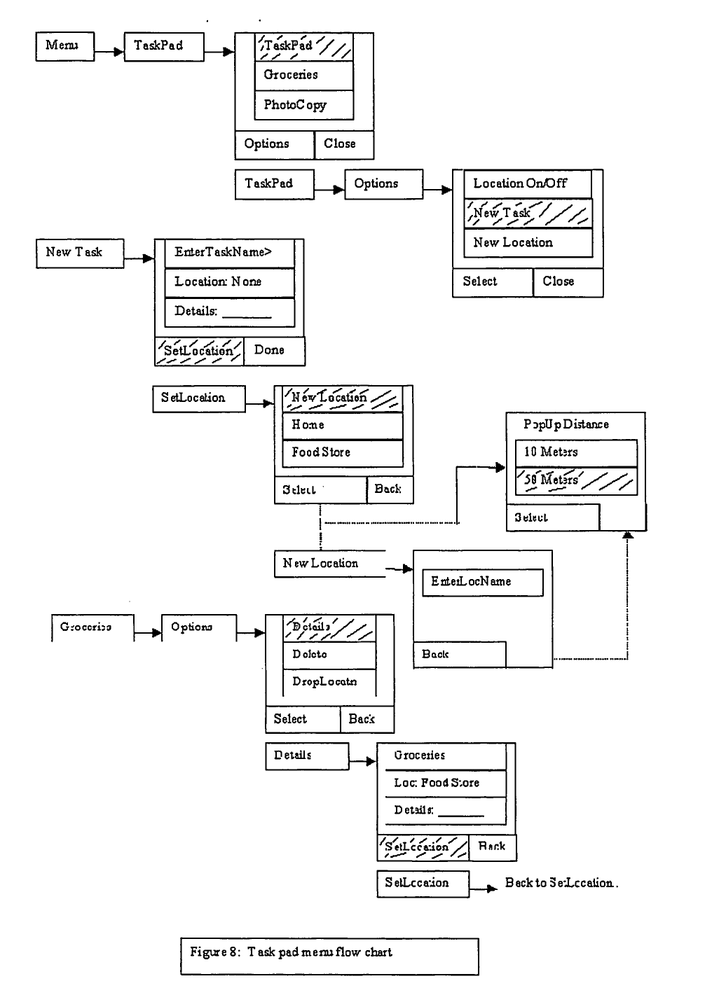

FIG. 7 expands the optimization strategy by optimizing for multiple user device locations while coordinating shared activities. Thus similar algorithmic strategies are used, only now the remote system, such as a server, or direct communication between mobile devices in the case of processing units on the devices, communicates via location based information of the devices is made available to the processing unit which optimizes for two or more user locations rather than for one individual user.

FIG. 8 demonstrates one possible user selection series and menu options for users to store a location, store a task, associate a location with a task or a task with a location, and dissociate tasks and locations.

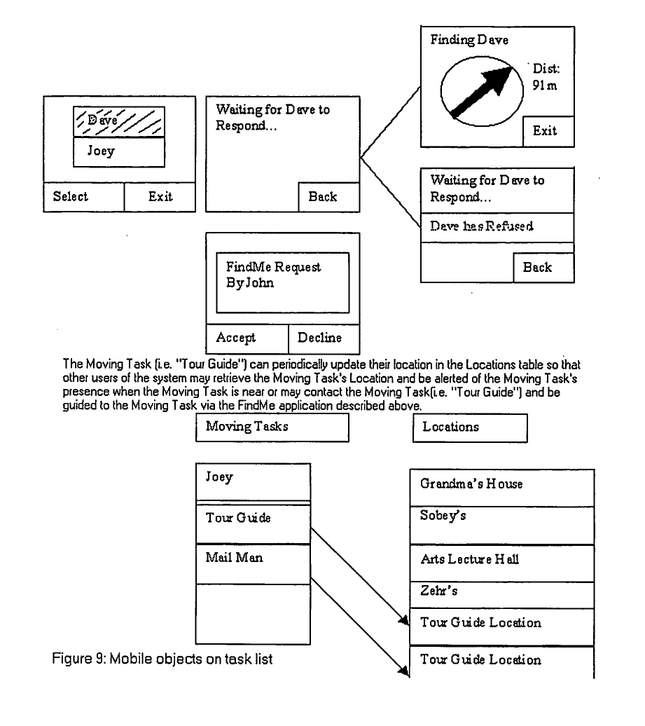

FIG. 9 allows users to place moving targets (ie talk to someone when in vicinity) on their task list. Such moving targets could be locations of other mobile computing devices. For instance, if a user needs to speak with someone on their contact list, the user could consider that a task and using communication through a server or directly between devices, one or both devices can be alerted if the other is within the threshold distance metric.

FIG. 10 demonstrates the possibility of recording locations temporarily for organizational purposes. The example used is that of parking a car or bike at a temporary location, whereby the user leaves the item to pursue other activities, similar to organizing your tasks, you may need to return to the temporary location to retrieve your item (such as your car or bike) before resuming other activities. Thus the user stores the location prior to leaving the item, and when attempting to return to the item location, the device, using the location associated with the stored item and the current device location, the device can direct the user to the items temporarily stored location. The user can dissociate the item with the location upon arrival at the temporary location, before moving the item, or even avoid updating the temporary location by leaving a similar device on the mobile item and using the method described in FIG. 9.

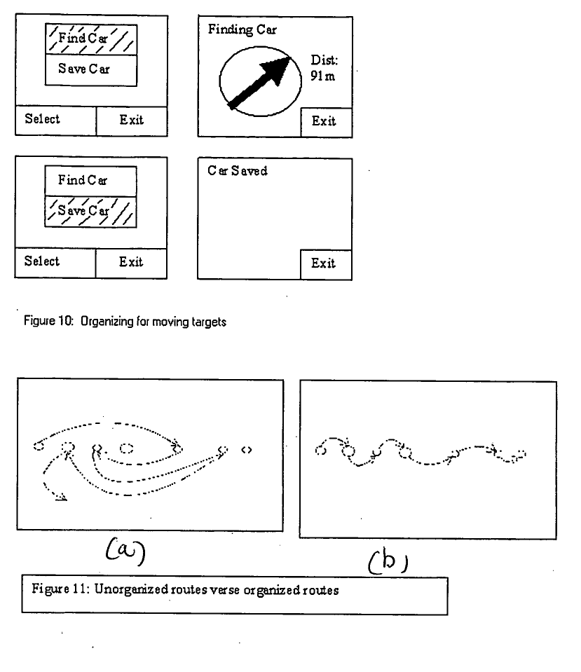

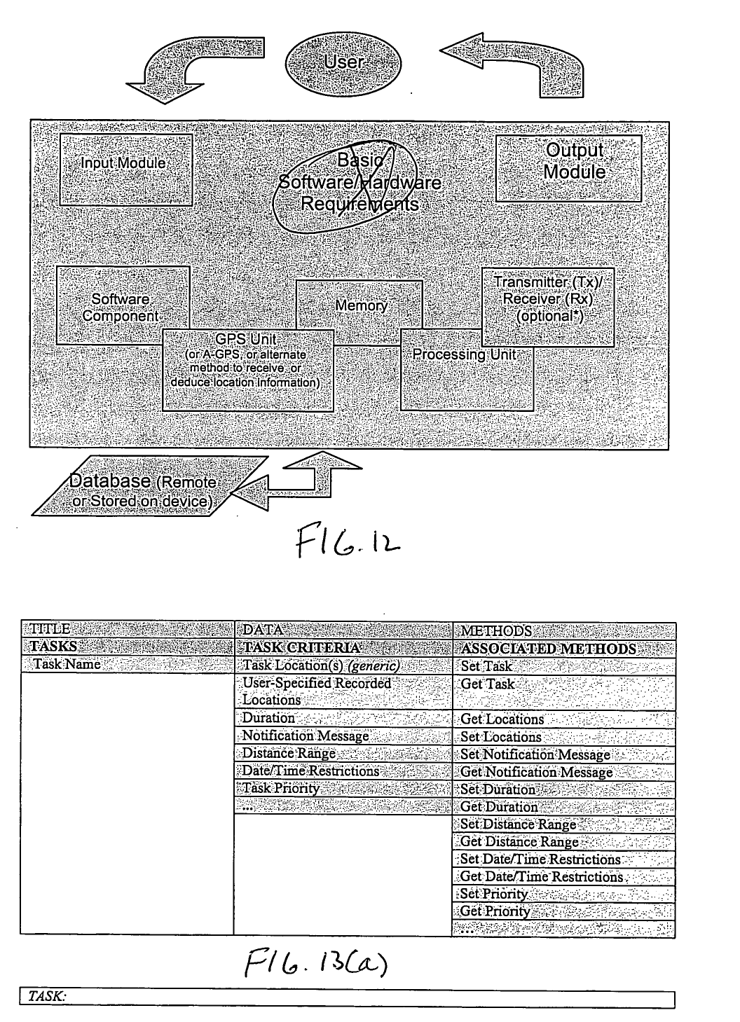

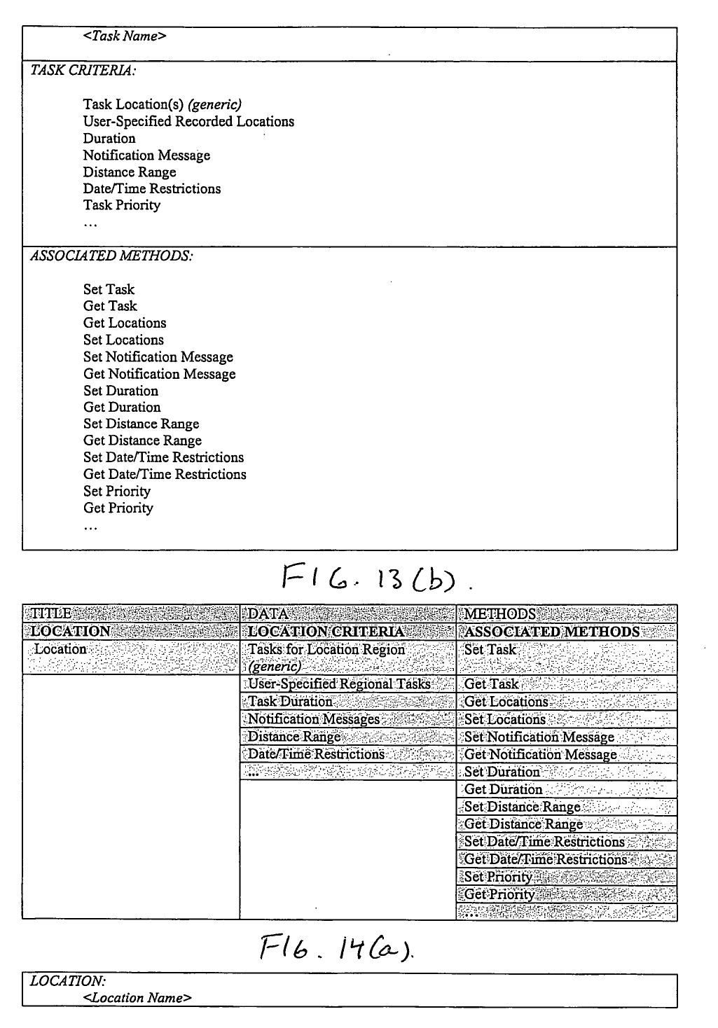

FIG. 11 depicts a scenario (FIG. 11(a)) whereby a user visits various locations in a non-optimal order, in this scenario frequently back-tracking, and possibly a symptom of using time-based organization or lack of organization. FIG. 11(b) depicts a device user traversing the same points in a shorter distance route. A comparison illustrates wasted time in terms of distance, although the graph could have weighted edges for various criteria used to optimize the user schedule as specified by the user (specified as values for criteria in the database).

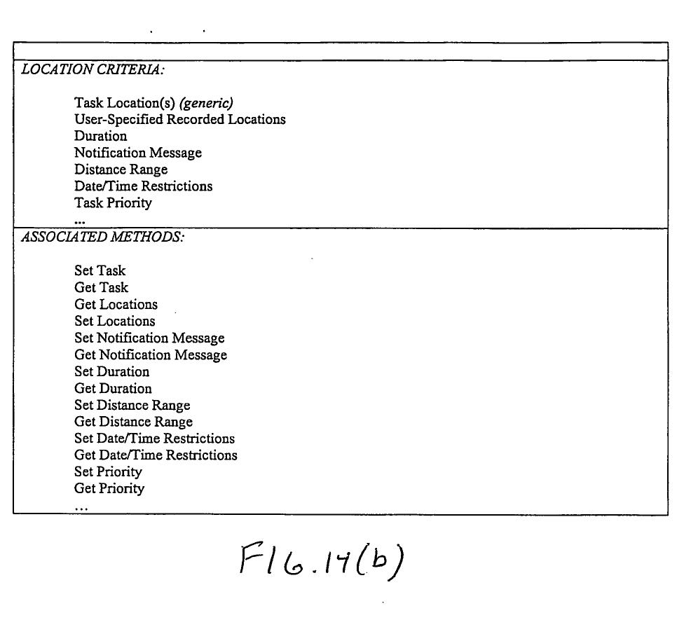

Referring to FIG. 12, shows basic components that may be used for a user's mobile device to run RLRSO software. As seen from this schematic, RLRSO can run on most mobile devices such as cell phones, PDAs, or even laptops, provided the devices have access to information allowing the device to deduce it's location.

The recordable location-based reminder system acts as an organizer for location-based information alone or in conjunction with other task organization systems. The system uses a mobile electronic device with access to location-based information for the device's current location and the location of other task locations. Information may be placed on the device either through user input methods directly to the device or by downloading the information from a neighboring device such a server of personal computer. Such a device may be a Personal Computing Device (PCD), a cell phone, or any mobile device with access to location information. Such location information may be obtained using the Global Positioning System (GPS), cell phone triangulation, or alternate means.

Location information retrieving methods for the device would include (but are not limited to) homing beacons, direct satellite, or delay calculations from the device's transmitted and received signals.

Beacon configuration would be composed of beacons positioned with-in an area in order to identify the location of a mobile device. The mobile device in this example would receive location information from the beacon configuration via a transmitter and receiver on the mobile device.

A direct satellite method would be similar to the GPS method, except that it deduces a users' location using other satellites and is not limited to the subset of satellites specifically designed for location-retrieval.

Calculating delay from communications between the mobile device and a transmitting and receiving unit of known location, such as a cell phone tower, would also allow for determining location information for a mobile device.

The preferred embodiment of an RLRSO contains a database of information either stored on the mobile device or on a remote device, such as a server, a web page, or personal computer whereby the remote device can transfer information to the mobile device. The database of information contains a list of tasks the user intends to complete. Additional information can also be stored in the database, such information includes but is not limited to: Location of tasks, time of tasks, time-ranges for tasks, priority rankings of tasks, importance of tasks, task duration, and reminder distances for tasks.

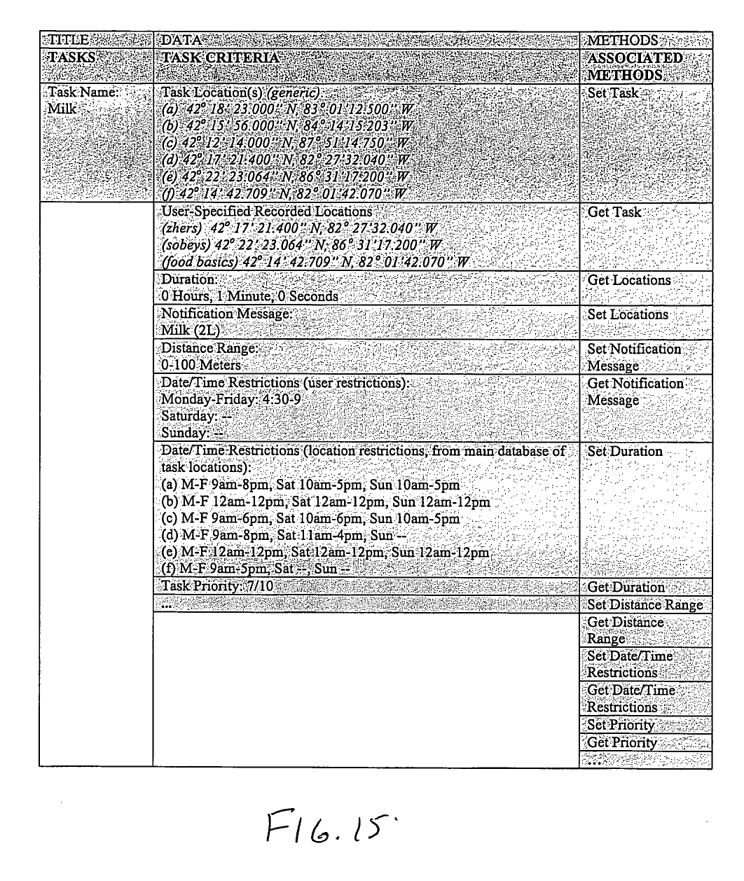

Referring to FIG. 13(a), database appearance from task perspective (column representation) illustrates one possible database appearance from a task perspective containing information and other criteria for use with the RLRSO.

Referring to FIG. 13(b), database appearance from task perspective (row representation) is an alternate representation of the possible database appearance from a task perspective for the RLRSO database.

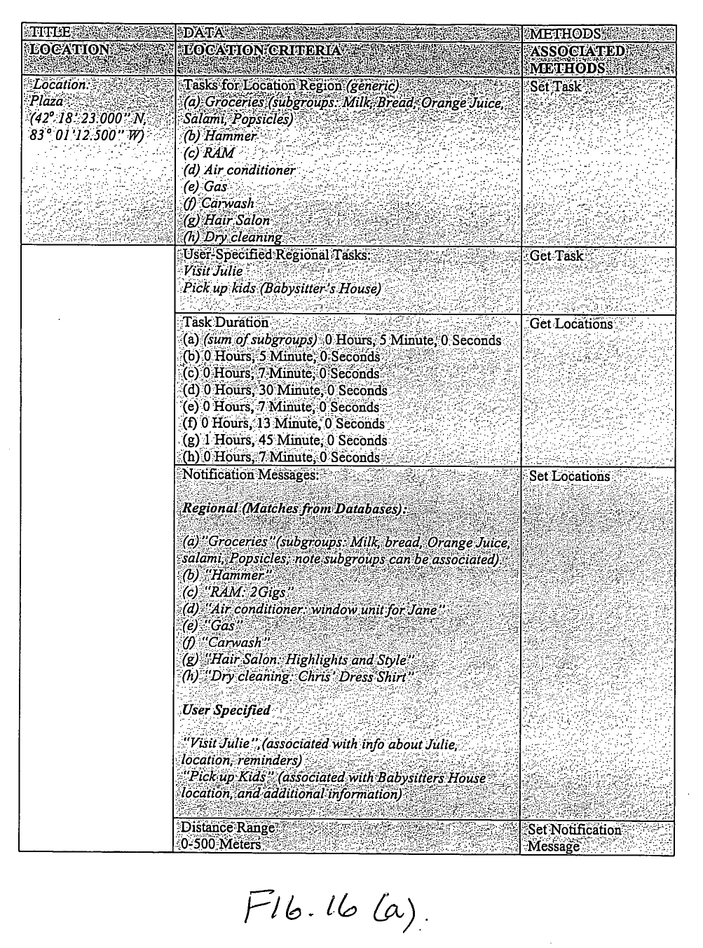

Referring to FIG. 14(a), database appearance from location perspective (column representation) illustrates one possible database appearance from a location perspective containing information and other criteria for use with the RLRSO.

Referring to FIG. 14(b), database appearance from location perspective (row representation) is an alternate representation of the possible database appearance from a location perspective for the RLRSO database.

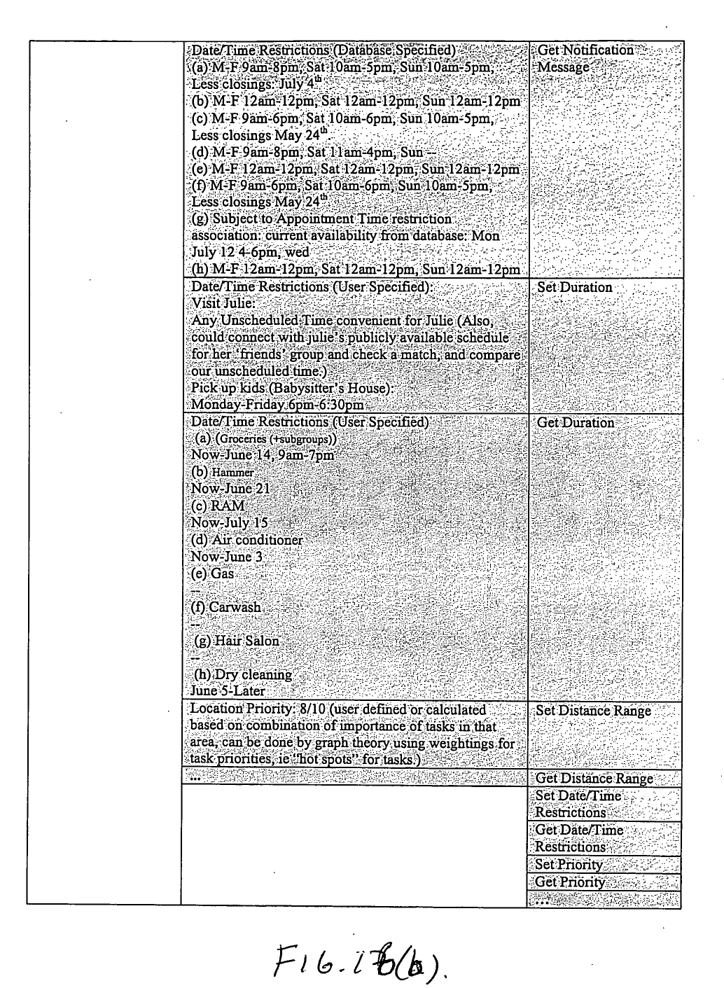

Referring to FIG. 15, populated database example from task perspective illustrates the usage of FIG. 13(a) by populating the database with example data for one possible task, it's related criteria, and associated methods.

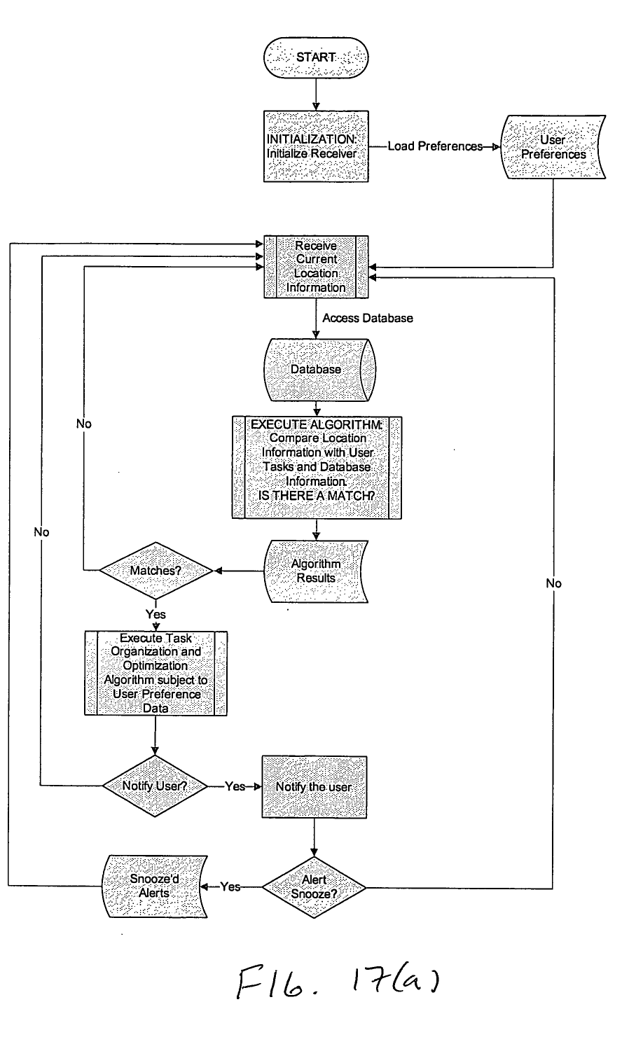

Referring to FIG. 16, populated database example from location perspective illustrates the usage of FIG. 14(a) by populating the database with example data for one possible location, it's related criteria, and associated methods.

Referring to FIG. 17(a), flow diagram for the RLRSO illustrates the generic RLRSO software implementation process.

Referring to FIG. 17(b), software flow diagram predefined processes further expands on process functionality for items shown in the flow diagram of FIG. 17(a).

Referring to FIG. 18, hardware, software, and database interactions using an externally accessible database is a block diagram representation of the interactions between hardware, software and the database for one possible configuration of the RLRSO implementation whereby there is an externally accessible device that the User's Mobile Device can access.

Referring to FIG. 19, hardware, software, and database interactions using an internally accessible database is a block diagram representation of the interactions between hardware, software and the database for one possible configuration of the RLRSO implementation whereby all information is contained on the device and is not remotely accessed. In this configuration it is possible that information can be loaded onto or off of the users mobile device by traditional means, or that the user is simply using their device as this example dictates irregardless of their device's capability to access remote information.

Referring to FIG. 13(a), each task is associated with all the items in the second column of the table. This means that each task is associated with multiple task locations (meaning multiple task locations for that task which would not be user-defined), as well as user-specified recorded locations (saved and labeled by users), duration (estimated duration of task, user specified), notification message, distance range, date/time restrictions and task priority. Other user preferences could also be taken into account.

Referring to FIG. 14(a), each location is associated with all the items in the second column of that table. This means that each location is associated with multiple Tasks (which are able to be completed with-in that location region, ie. their threshold distance of that location). Each location is associated with task location(s) (generic), user-specified recorded locations, duration (duration you intend to be in that location), notification messages (for that location), distance range, date/time restrictions, task priority (for that location).

Tasks can be associated with many locations where that task could be completed, and similarly, locations can be associated with many tasks that could be completed their range of the current location of the mobile device.

To send and receive information to and from the mobile device, various configurations are possible.

One such configuration would be where the mobile device wirelessly contacts a website, whereby the website has access to the database information. If the website were to obtain the user's co-ordinates (ie through instant messaging, email or other means, generally an invisible routine to the user), then the remote computer could run appropriate computer programs to determine local tasks which meet the users' preference criteria. Once calculations are completed, the appropriate information can be displayed to the website and the user can review the displayed information.

Alternatively, a method based on Instant Messages could be used where an RLRSO program installed on the users' mobile device sends off intermittent text messages containing location co-ordinates obtained from the hardware on the users' mobile device. The text messages are received by a remote server with corresponding software and databases to determine when a notification to the user is necessary. A message is then sent to the user, again possibly via e-mail, or IM (for example SMS).

Another option would be for the mobile device to have enough memory to hold all the required data (or a reasonable subset of data) and not require the use of transmitting and receiving data from remote devices. The user could load the information for their local area (or an area where they will be traveling with-in, or any desirable information) onto the device and use the Task Organizer features based solely on the devices onboard information.

This last configuration is in essence creating “Hot Spots” for downloading database information. Such “Hot Spots” could be created such that users can go to these set locations to promptly download local database information. Such information would generally be relevant to their area, although availability of other specialized database information may be available at these locations. Information on the device could also contain the location of other neighboring “Hot Spots” or regional “Hot Spots”.

Beacons could be especially useful for identifying mobile-device users' locations (especially with-in buildings and in regards to floor levels users are on) and would also assist with data-transfer (effectively “Hot Spots”) when in buildings. Aside from facilitating identification of the floor level an individual is on, beacons would also assist with possible difficulties in connecting to the database (since other means of network connections may be less effective indoors).

### EXAMPLE 1.0

Average user completing a list of tasks. The average user is an individual with a list of tasks to complete; some tasks may purely depend on location and others possibly with time constraints. The user carries a mobile device and the user may possibly set a location they wish to end up as well as a time limit for completing tasks. The device guides the user through completing as many tasks as possible, making value decisions in terms of task importance, location, etc, to optimize the user path. The user may at some point stop listening to the invention, but the invention will continue to optimize based on where the user has wandered to.

### EXAMPLE 2.0

Group of users completing a list of tasks, such as a family. The average family must coordinate tasks such as groceries, picking up the kids, and other not-so-frequent events or changes in schedules. One family member could notice they are out of milk, and by selecting it on the family's task list (with or with-out distance trigger values), other family members that are close to the grocery store could be alerted and purchase milk while they're there. Similarly one member could sign-on to the task so other family members know it's taken care of. This of course can be completed for multiple items.

### EXAMPLE 3.0

Construction Site application. At a construction site there may be a number of activities that must be completed and a number of individuals trying to coordinate activities. Using this device, planning can be simplified by recording the location of various events, such as where to dig a hole, where to place the foundation, and other tasks including details on each. Those in charge can assign workers to various tasks remotely based on progress or other factors, alternatively workers could view their task list which could be organized in terms of both priority as well as time (for example coordinating tasks which require multiple workers). The system would also be able to keep statistics on workers, such as how long they actually spent at the work site, or how long each task took them (based on location of task) and other data. Such data could be used to optimize the group dynamics by: assigning individuals to tasks they're most efficient at, or recognizing workers who are not spending the required time at the work site.

### EXAMPLE 4.0

Car Locating Scenario. Wandering around a parking lot trying to find your car (bike, vehicle, or other object) is a common occurrence. Such tasks can be organized by recording the location of the car prior to departing. When the user wishes to return to the car, they can select to find the car and be directed back to the vehicle.

### EXAMPLE 5.0

Wedding or Conference Organization. Weddings and Conferences are events that require much preparation. This scenario allows the bride or organizer to know, based on the task list: what still needs to be done, who has signed on to which task, who has signed off of tasks, etc. For each person sharing or helping with tasks, each person has the aforementioned invention whereby they use it to sign on and off of these tasks. Or even alert group members of concerns.

### EXAMPLE 6.0

The Traveling Salesman. Often individuals must visit many people even on the average business day. Sometimes it can be hard to coordinate whom to visit when and recall the details that may be important when visiting them. This invention can allow users to specify in terms of importance, who they must visit and, in terms of optimizing time, distance traveled, or other factors (even possibly the schedule of the other individual), it can alert them of the best route. Alert messages can be triggered when in the vicinity of a client to alert the user as to the details of the last meeting, the dog's name, or any other details. This invention thus would make it easier for a new employee to fill the position of another by using their records, thus directing them to who, when, giving details about clients, or other information.

### EXAMPLE 7.0

Organizing Travel Information. Traveling can be difficult, especially when disoriented and/or unable to speak the language. This invention allows the user to record meeting spots, hotel locations, restaurants, and other places and organize a schedule for what time to be at each location, as well as possibly sign on to tasks they have not logged locations for. Connecting to a remote system (such as connecting to a website with location data) that may have local information, the device can then optimize a route for the user based on what events they wish to complete, time constraints, and location information pre-recorded in the remote database. The device then helps to alleviate difficulties with asking for directions since it guides you to the locations the user selected.

### EXAMPLE 8.0

A list involving moving Task Locations (ie speaking to individuals) Events with large groups of individuals, such as frosh orientation at universities, where speaking to certain individuals may be on the task list of organizers and can thus pose a difficulty in finding the location of that task. The invention in this case would now not have a static location for that task, but with both individuals having the said invention, the location information of the individual seeking the task as well as the moving individual's location can be accounted for and they may be alerted when in the vicinity of that task. It can be noted that any method of receiving location-based information of the second party can allow the first individual to use the invention to meet up with them.

### EXAMPLE 9.0

The database could include prices of items at each of the locations, brands available at locations, and other relevant information. Similarly services and products listed could be accompanied by ratings on those services and products, and users could contribute to the database by offering feedback. Databases could update schedules to find overlapping availability between individuals and their desired time-constrained tasks (or other restrictive criteria). For example, the hair salon updates times for when they have openings, and users who want hair appointments can get notification based on their user settings and tasks combined with salon time availabilities.

### EXAMPLE 10.0

For anyone unfamiliar with an area, on a business trip, on vacation, traveling, or anyone who's generally forgetful, or the typical “traveling salesman”, or those with memory difficulties (such as Alzheimer's), the device can guide you to near-by locations where you can complete the tasks on your task list, based on your preferences. The device could also inform you of information associated with any of the stored items, tasks, or locations (such as names of individuals at the location you're currently at, operation hours for the locations of tasks, or co-ordinate multiple people or business schedules by comparing their databases information.) For example, the task “visit Julie” is associated with information about Julie (how I know her, her dog's name, the location of her house, which direction it's in, its distance relative to me), when I reach Julie's house, that location may be associated with a shorter distance metric thus pulling up more information (when I saw her last, her daughter's name, etc). This “visit Julie” example could also be used for busy salesmen, or travelers who have difficulty remembering everything new to them. (Scenario also works for locating a grocery store, thus using a large distance-trigger metric, then arriving at the grocery store, pulling up a shorter distance-triggered metric for your grocery list. Such notification would occur upon entering any grocery store associated with the items the user needs).

### EXAMPLE 11.0

When a database contains locations of mass groups of people (houses, offices, etc similar to a telephone directory), and associated with each person is a (self-advertised) public list of items that they choose to share (like sharing files, where you can share with select “groups” of people), such that if you had “hammer” on your “to borrow” list (rather than the otherwise assumed task of buying one) a friend on your network might have “hammer” on his list of shared items. Your task-scheduling program may suggest the location of your friend as being that of the closest hammer. Similarly, your device could record that you borrowed the hammer, and move the ‘hammer’ on your friends list to be ‘unavailable’, as well as remind you later to return the hammer when you are near your friends' location.

### EXAMPLE 12.0

Another example would be that of a “small world” or specified region, such as an amusement park. For such areas, a database can be created to contain only information relevant to the park area, and update criteria such as the length of lines for rides, times of shows, lost and found items, lost children (or missing persons) list, and other park features or notifications. In this scenario, we could compare with rides that the individual selected that he/she wants to go on (or activities to attend), accounting for ride duration and estimated line times for rides. System can optimize by collaborating information from all attendees at the amusement park to optimize so we can give everyone as much of what they want as we possibly can. The mobile device could also track what rides the user has already been on by updating the ride to “completed” when the user is tracked to be with-in the actual ride area (tracked by beacons in the park, or GPS, or A-GPS, etc). Note, amusement parks or especially indoor facilities (which may otherwise suffer from poor location information) could make use of the “Hot Spot” concept for improving service to the mobile device (especially in rural regions such as rural geological parks). The amusement park example as well as the geological park scenario, are example of creating a specific-purpose specialty database used for planning, scheduling, sharing, and organizing by only a subset group of people with criteria only relevant to their scenario. (ie. individuals or groups can create their own meaning and criteria for events, preferences, and organization simply by altering the database information and creating methods of measuring/determining event importance based on their preference criteria).

### EXAMPLE 13.0

By sharing schedules or having ‘Group’ lists and tasks, individuals can step-in and take over another individual's schedule and/or to-do list items. Sharing would be a strategic way of group optimization since the ‘all-of-you’ covers more area that the ‘one-of-you’ and if you're closer to a task that your friend has to do, and they're closer to tasks you have to do, then we can all complete our scheduled tasks more efficiently. This is merely location-based reminder notifications using a database as well as multiple individuals' locations and user preference constraints to optimize the efficiency of task completion for an inter-dependant group. (In scenarios such as this, users would have the option of “hiding” their location from the network, or temporarily signing in and out of group task lists, or only sharing with certain other individuals, ie smaller groups).

### EXAMPLE 14.0

We can also note that items in the database can be mobile, such as hotdog stands, or parked cars, so long as we update the database it will still be useful criteria for scheduling. Such locations could be saved simply by saving a way-point and storing it to the database as the new location of the mobile item. (By tracking velocity, the device could make an educated guess as to the region where you parked your car, and thus automatically use those co-ordinates for optimization, alternatively, your car could have an onboard GPS unit (or alternate location-retrieving mechanism) and be able to communicate that to your mobile device (ex. OnStar). Additionally, moving objects could also be used in scheduling provided they communicate their position intermittently to update the database. An example of this would be buses on a public transit route. To be useful, the database simply needs to be updated when mobile items change their locations.

### EXAMPLE 15.0

A further application of this would allow stores to gage demand if users allowed some of their information to be either public, or made available for statistical purposes. Such usage would allow stores to note what the demand is for a particular item and stock their shelves accordingly. (ie Christmas, or a play or concert ticket demand, etc.) Tracking would also allow for noting path tendencies (statistical analysis, correlations, etc) and can be used for finding and exploiting tendencies such as noting trends among users going to similar places, following similar paths for advertisement or other purposes.

It will be understood by those skilled in the art that this description is made with reference to the preferred embodiment and that it is possible to make other embodiments employing the principles of the invention which fall within its spirit and scope as defined by the following claims.

What is claimed is:

1. A location based computing system, comprising:
a mobile device aware of its location and one or more tasks that a user of the device wishes to perform;
a locations database for storing a plurality of locations and a plurality of tasks that can be performed at the locations, wherein the tasks are associated with the locations and at least one of the tasks can be performed at multiple locations;
determination means for communication between the mobile device and the database to determine when the mobile device is within a given proximity of a location in the database at which a task can be performed;
notification means for providing a notification to a user through the mobile device when the mobile device is within the given proximity of a location in the database at which a task can be performed.

2. The system of claim 1 wherein the mobile device comprises a GPS unit through which the device is made aware of its location.

3. The system of claim 1 wherein the mobile device comprises a database for storing tasks that the user wishes to perform.

4. The system of claim 1 wherein the location database is remote from the mobile device, and the mobile device comprises a wireless transmitter and receiver through which the mobile device obtains information from the database.

5. A location based computing system, partially or entirely portable, comprising:
a device to receive location information
a memory unit to store information, whereby the memory unit is located either on the mobile device or at a remote accessible location,
a software component allowing users to store and/or modify location based information, whereby modifications can occur regardless of device location,
capability of outputting information relating to the designated region for the mobile unit upon determining that it is in a set vicinity of the designated region for the information,
including a processing unit either on the device or on a companion device, where the companion device could possibly be a component of a networked system,
a software component acting as an organizer for location based information; such organization could be based on, but not limited to: current distance from listed items;
importance rankings of listed items; time restraints of items; route planning based on multiple locations and/or time constraints and/or item priority, etc; specific location based information of stored items such as GPS coordinates or alternative equivalent systems.

6. The location-based system of claim 5, wherein the output information may further include: location-based information pre-programmed for the user. Such methods may comprise, but are not limited to, information stored in neighboring devices or information pre-programmed by alternate means.

7. The location based information system of claim 6, wherein the programs and/or their parameters are adjustable on the device or, via adaptable means, re-calculated on the device. Such alterations could be, but are not limited to: user specified location deletions or additions to pre-set destination sequences; user additions, deletions or modifications of any information on the device.

8. The location based system of claim 5, wherein the portable device is a wireless phone, PDA, laptop, or any other mobile unit acting as a medium or entire platform for the system.

9. The location based system of claim 5, wherein the device may calculate distances, directions, and other informative information via information received through, but not limited to: user inputs, communications with other devices, communications internally with pre-programmed information.

10. The location-based system of claim 5, wherein location based information pertains to any information programmable in a device via the device or alternate devices, to inform when the device is in a designated region, or to inform of any preset linked information to the designated region.

11. The location based system of claim 5, wherein modes can be set by users allowing, but not limited to: status modes such as approachability; device user's route plans possibly for potential pairing or clustering of device users; sharing of location-based lists possibly determined by selecting users to share with; subscribing to user groups, databases, or specific classifications of data within such databases; advertising or posting to create groups.

12. The location based system of claim 5, further comprising software rendering the device the capability to record present device locations at regular intervals and store such sequences of locations complete with a label or tag of some description, as well as recording prime points of importance in the sequence, and additive information for those points either while at the point or at any time after the points (and the sequence of locations) have been stored. Sequences programmed in a device are accessible via the label or tag associate with the grouping, but such sequence points can be individually accessed.

13. The location based system of claim 5, further comprising a method for determining user orientation and/or direction of travel. Such methods may incorporate but are not limited to methods requiring a compass (electronic or otherwise), or transmitter/receiver distance/time calculation methods.

14. The location based system of claim 5, wherein location based database information can be grouped in terms of categories, wherein the distinguishing factor amongst a group of information is the location itself. Such results can be, but is not limited to, dynamic usage by the organizer of claim 5.

15. The location based system of claim 5, wherein there is a fixed record to describe the temporary location of mobile objects, such as but not limited to: vehicles. Wherein location information can be updated or nullified by the user.

16. The location based system of claim 5, wherein location based information and other relevant related information is stored in a database and can be accessed (for both uploading and downloading) by a group of persons using the location based system of claim 5.
